(19) United States
(12) Patent Application Publication
(10) Pub. No.: US 2017/0361806 A1
(43) Pub. Date: Dec. 21, 2017

(54) ULTRASOUND ASSISTED LOCATION AND ACCESS CONTROL

(71) Applicant: GM GLOBAL TECHNOLOGY OPERATIONS LLC, Detroit, MI (US)

(72) Inventors: Kobi J. Scheim, Pardess Hanna (IL); Nadav Lavi, Ramat-Hasharon (IL); Wen Gu, Novi, MI (US); Eli Tzirkel-Hancock, Ra'Anana (IL)

(21) Appl. No.: 15/497,616

(22) Filed: Apr. 26, 2017

Related U.S. Application Data
(60) Provisional application No. 62/352,339, filed on Jun. 20, 2016.

(51) Int. Cl. B60R 25/10; B60R 25/102; H04W 4/04; B60R 25/20; G05D 1/00; H04W 12/08; H04L 29/08; H04M 1/02

(52) U.S. Cl. CPC B60R 25/1009; B60R 25/20; B60R 25/102; G05D 1/0016; G05D 1/0022; H04W 4/046; B60W 2420/54; B60R 2325/205; B60W 2422/90; B60W 2550/40; H04L 67/12; H04M 1/0202; H04W 12/08; B60W 2750/40

(57) ABSTRACT

A system and method for performing an operation at a vehicle is disclosed. The system includes a first acoustic transceiver that transmits and receives inaudible acoustic signals and a second acoustic transceiver that transmits and receives inaudible acoustic signals. The second acoustic transceiver is stationary with respect to the vehicle. A processor receive an inaudible acoustic signal transmitted between the first acoustic transceiver and the second acoustic transceiver, determines a location of the first acoustic transceiver with respect to the vehicle from the received signal, and performs an operation at the vehicle based on the location of the first acoustic transceiver with respect to the vehicle.

### CROSS REFERENCE TO RELATED APPLICATIONS

This application claims priority from U.S. Provisional Application Ser. No. 62/352,339, filed Jun. 20, 2016, the contents of which are incorporated herein by reference in their entirety.

### FIELD OF THE INVENTION

The subject invention relates to locating objects with respect to a vehicle and, in particular, to a system and method for communicating between a vehicle and a mobile device in order to control an operation at the vehicle based on a location of the mobile device.

### BACKGROUND

A driver performs different actions depending on his or her location with respect to a vehicle. Therefore, knowing the location of the driver can be used to create a more convenient and enjoyable automotive experience. The driver generally carries with him or her various objects that have communication abilities, such as a smartphone or other electronic device. Accordingly, it is desirable to provide a system for determining the location of such objects carried by the driver in order to perform an appropriate operation at the vehicle.

### SUMMARY OF THE INVENTION

In one exemplary embodiment, a system for performing an operation at a vehicle includes a first acoustic transceiver that transmits and receives inaudible acoustic signals; a second acoustic transceiver that is stationary with respect to the vehicle, wherein the second acoustic transceiver transmits and receives inaudible acoustic signals; and a processor configured to: receive an inaudible acoustic signal transmitted between the first acoustic transceiver and the second acoustic transceiver, determine a location of the first acoustic transceiver with respect to the vehicle from the received signal, and perform the operation at the vehicle based on the location of the first acoustic transceiver.

The inaudible acoustic signal may be transmitted from the first acoustic transceiver to the second acoustic transceiver, transmitted from the second acoustic transceiver to the first acoustic transceiver, or a signal transmitted from the first acoustic transceiver in response to an inaudible acoustic signal from the second acoustic transceiver. Alternatively, the inaudible acoustic signal may be transmitted from the second acoustic transceiver to the first acoustic transceiver and either the location is determined at the first acoustic transceiver, or the received signal may be forward to the vehicle and the location may be determined at the vehicle.

In an embodiment, the second acoustic transceiver includes an array of second acoustic transceivers and the processor triangulates a location of the first acoustic transceiver from a plurality of transmitted and received signals transmitted between the array of second acoustic transceivers and the first acoustic transceiver. In another embodiment, the transceivers of the array of second acoustic transceivers communicate sequentially with the first acoustic transceiver.

The first acoustic transceiver may be included in a hand-held mobile device. The mobile device transmits a security code to the vehicle and the processor activates the second transceiver when the security code matches a security code stored at the vehicle. The mobile device transmits the security code using electromagnetic signals. The security code is installed at the mobile device and provided to the vehicle from a remote location.

Performing the operation may include, for example, opening a door of the vehicle, starting the vehicle, connecting a phone call to the vehicle, sounding an alarm, calling a separate phone, preventing the vehicle from being locked, and sending an outgoing message to a remote system.

In another exemplary embodiment, a method for performing an operation at a vehicle includes: transmitting an inaudible acoustic signal between a first acoustic transceiver and a second acoustic transceiver affixed to the vehicle, determining, at a processor, a location of the first acoustic transceiver with respect to the vehicle from the received signal, and performing the operation at the vehicle based on the location of the first acoustic transceiver with respect to the vehicle.

The inaudible acoustic signal may be transmitted from the first acoustic transceiver to the second acoustic transceiver, transmitted from the second acoustic transceiver to the first acoustic transceiver, or a signal transmitted from the first acoustic transceiver in response to an inaudible acoustic signal from the second acoustic transceiver. Alternatively, the inaudible acoustic signal is transmitted from the second acoustic transceiver to the first acoustic transceiver and either the location is determined at the first acoustic transceiver or the received signal is forwarded to the vehicle and the location is determined at the vehicle.

In an embodiment, the second acoustic transceiver includes an array of second acoustic transceivers and a location of the first acoustic transceiver is triangulated from a plurality of inaudible acoustic signals transmitted between the array of second acoustic transceivers and the first acoustic transceiver. The transceivers of the array of second acoustic transceivers may communicate sequentially with the first acoustic transceiver.

In an embodiment, the first acoustic transceiver is included in a mobile device that is mobile with respect to the vehicle. A security code is transmitted from the mobile device to the vehicle and the second transceiver is activated when the security code matches a security code stored at the vehicle. The mobile device may transmit the security code using electromagnetic signals. The security code may be transmitted to the mobile device from a remote location.

The operation to be performed may include, for example, opening a door of the vehicle, starting the vehicle, connecting a phone call to the vehicle, sounding an alarm, calling a phone, preventing the vehicle from being locked, or sending an outgoing message to a remote system.

The above features and advantages, and other features and advantages, are readily apparent from the following detailed description when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 shows a passive entry passive start (PEPS) system that uses acoustic signals to determine a location of an object with respect to a vehicle and to perform an operation at the vehicle based on the location of the object;

FIG. 2 illustrates a communication protocol between a mobile device and a vehicle; and

FIG. 3 shows a graph resulting from an experiment showing range determination for a mobile device placed at a selected location with respect to a transceiver using the acoustic signals discussed herein.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

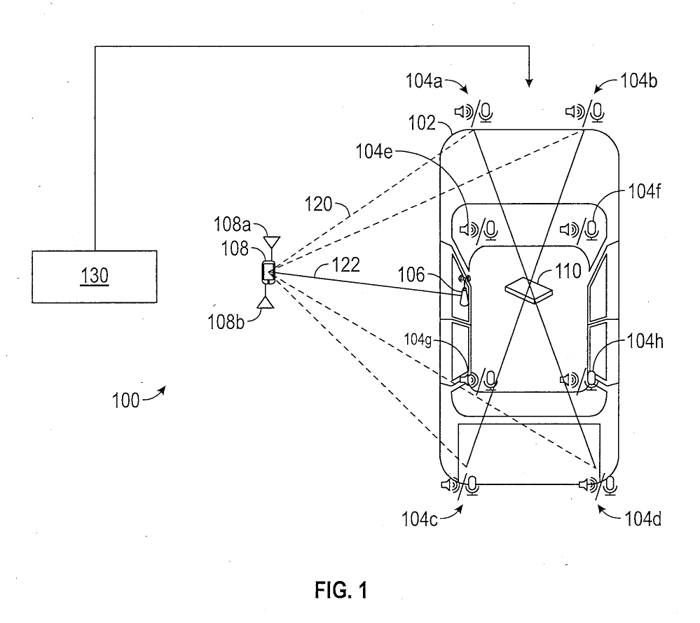

In accordance with an exemplary embodiment of the invention, FIG. 1 shows a passive entry passive start (PEPS) system 100 that uses acoustic signals to determine a location of an object with respect to a vehicle and to perform an operation at the vehicle based on the location of the object. As discussed herein, an “acoustic signal” generally refers to an acoustic signal that is in an inaudible frequency range. This frequency range may include frequencies greater than about 16 kiloHertz (kHz). In an embodiment, the acoustic signals of the invention have a frequency that is in the range between 16.5-17 kHz to 18.5-19 kHz. In another embodiment, the acoustic signal can include a signal having a frequency greater than about 20 kHz, or within an ultrasonic frequency range.

The system 100 includes a vehicle 102 having a plurality of acoustic transceivers 104a, 104b, 104c and 104d located at separate locations around the vehicle 102. Additional acoustic transceivers 104e, 104f, 104g and 104h are also shown. In general, the acoustic transceivers 104a, 104b, 104c and 104d are more suitable for communication with an object outside of the vehicle, while acoustic transceivers 104e, 104f, 104f and 104h are more suitable for communication with an object inside the vehicle 102. The number of transceivers shown in FIG. 1 is just for illustrative purposes only and is not meant to be a limitation of the disclosure.

In the illustrative embodiment of FIG. 1, acoustic transceiver 104a is located at a left front bumper location, acoustic transceiver 104b is located at a right front bumper location, acoustic transceiver 104c is located at a left rear bumper location and acoustic transceiver 104d is located at a right rear bumper location. The acoustic transceivers 104a, 104b, 104c and 104d are capable of transmitting and receiving acoustic signals. Furthermore, vehicle 102 includes an electromagnetic transceiver 106 for communicating via electromagnetic waves. In one embodiment, the electromagnetic transceiver 106 transmits and receives signals using a short-range communication protocol, such as Bluetooth. However, other electromagnetic frequency ranges and communication protocols can be used in alternate embodiments.

A handheld device or mobile device 108 moves with respect to the vehicle 102 and is generally carried by a passenger or driver of the vehicle 102. The mobile device 108 can be a smartphone or other mobile device in various embodiments. The mobile device 108 may also be a key fob attached to keys for the vehicle 102. The mobile device 108 includes an acoustic transceiver 108a that transmits and receives acoustic signals 120 and thereby communicates with transceivers 104a, 104b, 104c and 104d. The mobile device 108 also includes an electromagnetic transceiver 108b for transmitting and receiving electromagnetic signals 122 with the electromagnetic transceiver 106 of vehicle 102. The mobile device 108 may include a processor for operating the acoustic transceiver 108a and performing calculations discussed herein.

The vehicle 102 includes a control unit 110 for performing various operations disclosed herein. The control unit 110 includes a processor that operates the acoustic transducers 104a, 104b, 104c and 104d to communicate with the acoustic transceiver 108a through acoustic signals and operates electromagnetic transceiver 106 to communicate with electromagnetic transceiver 108b through electromagnetic signals. The processor of control unit 110 also runs programs that determine a location of the mobile device 108 with respect to the vehicle 102 using acoustic signals 120 and/or electromagnetic signals 122 and that perform an operation based on the determined location of the mobile device 108.

To initiate a communication between the mobile device 108 and vehicle 102, the mobile device 108 transmits an access code or security code to the vehicle via electromagnetic signals 122 between electromagnetic transceiver 108b and electromagnetic transceiver 106. In one embodiment, the security code is a code that is permanently stored at the mobile device 108. In another embodiment, the security code is provided to the mobile device 108 on a temporary basis. For example, a temporary security code can be communicated to the mobile device 108 from a remote system 130. Alternatively, the temporary security code can be communicated to the mobile device 108 before the mobile device 108 is dispatched from the remote system 130. When the remote system 130 communicates the security code to the mobile device 108, it also communicates the security code to the vehicle 102 so that the mobile device 108 can be verified at the vehicle 102. The temporary security code can have a pre-set expiration time or can be cancelled wirelessly by an action taken at the remote system 130. The vehicle 102 can initiate transfer of the security code to the mobile device 108 after receiving an access request from the mobile device 108. The vehicle 102 can contact the remote system 130 in order for the remote system 130 to provide the security code to the mobile device 108 in response to the access request. The communication protocol between the mobile device 108 and vehicle 102 can provide a multi back-and-forth information exchange (e.g. more than two pass).

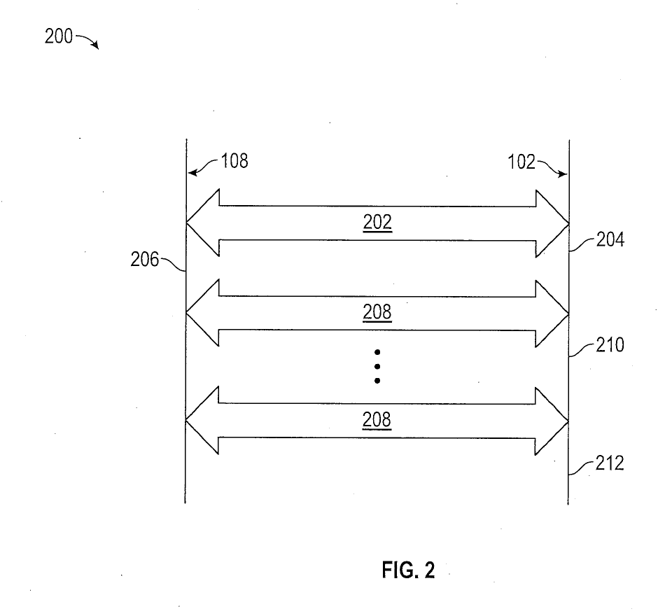

Referring to FIG. 2, with continuing reference to FIG. 1, a communication protocol 200 between mobile device 108 and vehicle 102 is illustrated. The mobile device 108 is shown on a left-hand side of FIG. 2 and the vehicle 102 is shown on a right-hand side of FIG. 2. The mobile device 108 and vehicle 102 begin communication using an electromagnetic signal 122 to perform a handshake protocol (box 202). The mobile device 108 sends out the security code to electromagnetic transceiver 106 of vehicle 102. The security code is sent from the electromagnetic transceiver 106 to the control unit 110 to thereby establish an ownership or other association between a person in possession of the mobile device 108 and the vehicle 102. The control unit 110 determines whether the security code matches a code stored at the control unit 110. When the security code matches the stored code, the control unit 110 activates (box 204) the transceivers 104a, 104b, 104c and 104d in order to commence communication with the mobile device 108 using acoustic signals. The control unit 110 may also send (box 202) an electromagnetic signal back to the mobile device 108 to tell the mobile device 108 to expect communications via acoustic signals in order that the mobile device 108 can activate (box 206) its acoustic transceiver 108a.

Once transceivers 104a, 104b, 104c and 104d and acoustic transceiver 108a have been activated, the mobile device 108 and vehicle 102 send acoustic signals back and forth (boxes 208) in order to determine (box 210) a location of the mobile device 108 with respect to the vehicle 102.

The location of the mobile device 108 can be determined by triangulation of the acoustic signals. In one embodiment, each transceiver 104a, 104b, 104c, 104d transmits an acoustic signal to the mobile device 108. For each acoustic signal received at the mobile device 108, the mobile device 108 transmits an acoustic signal in response. Each transceiver 104a, 104b, 104c, 104d determines a radial distance to the mobile device 108 (or range of the mobile device 108) from a time-of-flight between transmission and reception of acoustic signals. Calculating the crossing point of the circles associated with these radial distance measurements (i.e., triangulation) provides the location of the mobile device 108. The transceivers 104a, 104b, 104c, 104d can transmit signals simultaneously or sequentially. Alternatively, the mobile device 108 can transmit an acoustic signal and the transceivers 104a, 104b, 104c and 104d can determine the location of the mobile device from the acoustic signal. In an embodiment, the transceivers 104a, 104b, 104c and 104d each measure an intensity of the received acoustic signal and the control unit 110 determines the location of the mobile device 108 from the difference in the intensities. Alternatively, the control unit 110 can determine location of the mobile device 108 by recoding times at which the acoustic signals are received at each of the transceivers 104a, 104b, 104c and 104d. In another embodiment, the transceivers 104a, 104b, 104c and 104d transmit acoustic signals with audio codes and the mobile device 108 determines its location with respect to the vehicle 102. The mobile device 108 can transmit its determined location to the vehicle 102. In another embodiment, a combined version of ranging by time of flight measurements and power measurements can be used to calculate the location of the mobile device 108 relative to the vehicle 102. In another embodiment, the mobile device 108 transmits a voice code or signal and the transceivers 104a, 104b, 104c and 104d calculate the time of arrival of this signal. The times, which are measured relative to the vehicle 102 as measured at a local clock system of the vehicle 102, are differenced and the time difference of arrivals is used to calculate the location of the mobile device 108 relative to the vehicle 102.

The control unit 110 can perform any number of operations based on the determined location of the mobile device 108. For example, box 212 of FIG. 2 indicates that a door, such as a driver-side front door, can be opened when the mobile device 108 is within a set distance of the vehicle 102. The control unit 110 can track the movement of a person holding the mobile device 108 and determine that the person is approaching the vehicle 102 in order to enter the vehicle. Since the security code of the mobile device 108 has been confirmed, the control unit 110 can open the door for the person.

Additionally, the control unit 110 may start the vehicle 102 when the mobile device 108 is determined to be inside the vehicle 102. More particularly, the control unit 110 can start the vehicle 102 when the mobile device 108 is determined to be inside the vehicle 102 and driver's side door is determined to be closed or a button is pushed or some other associated condition is met or action is performed. When the mobile device 108 is a mobile phone or is associated with a mobile phone, the control unit 110 may connect the mobile phone to the vehicle 102 so that phone calls are directed through the vehicle 102. In another embodiment, the control unit 110 can prevent the vehicle 102 from being locked when the mobile device 108 is within a cabin of the vehicle 102. Alternatively, the vehicle 102 can call a separate phone when a driver locks the vehicle 102 with the mobile device 108 inside the vehicle 102. In another embodiment, when a person leaves the vehicle without the mobile device 108, the control unit 110 prevents the vehicle 102 from being locked or sounds an alarm. The vehicle 102 can select to use the externally-mounted transceivers 104a, 104b, 104c and 104d when the mobile device 108 is external to the vehicle 102 and the internally-mounted transceivers 104e, 104f, 104g and 104h when the mobile device 108 is internal to the vehicle 102.

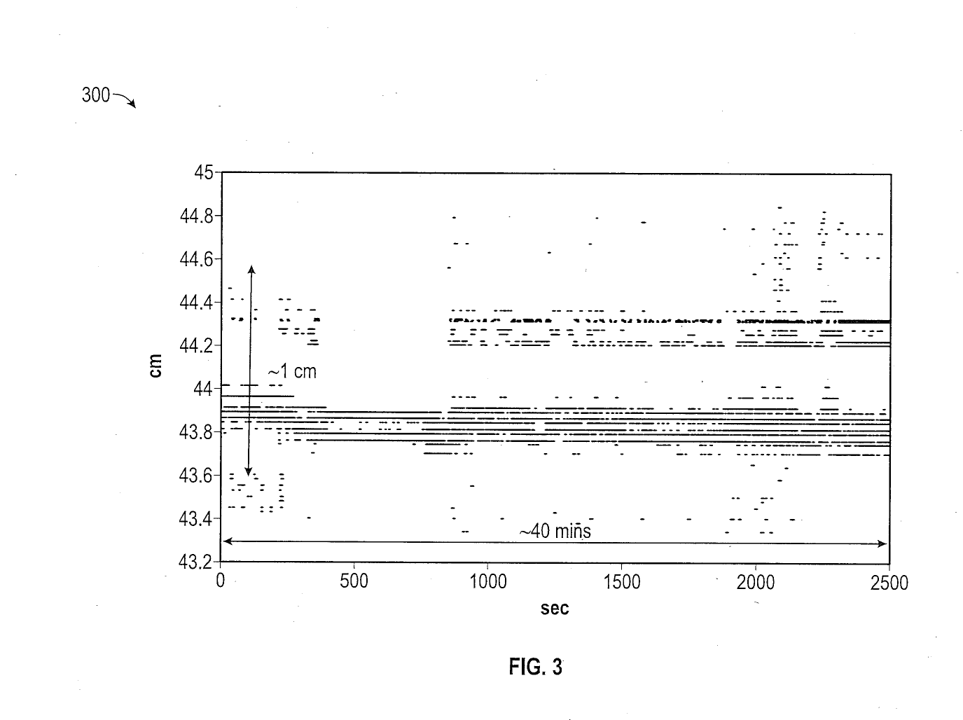

FIG. 3 is a graph 300 illustrating range determination for a mobile device 108 placed at a selected location with respect to a transceiver using the acoustic signals discussed herein. Time is shown in seconds along the abscissa and range is shown in centimeters along the ordinate axis. Dots indicate locations determined for the mobile device 108 at various points in time. As an illustrative example, using acoustic signals having a frequency of f=30 kHz and a velocity of sound is about v=340 meters/second, the wavelength of such acoustic signals about 1.13 centimeters. Therefore, the control unit 110 can determine the location of the mobile device 108 to within about 1.13 centimeters. The control unit 110 can therefore determine the location of the mobile device 108 with a high degree of accuracy. FIG. 3 shows that the range of the mobile device 108 is determined to within about 1 centimeter consistently over a time interval of about 2500 seconds (about 41 minutes), thereby demonstrating the viability of the invention.

The disclosure herein therefore provides a system and method for determining a location of a mobile device 108 with respect to a vehicle and enables the control unit 110 to perform an action that coincides with the actions or intentions of a driver or passenger of the vehicle 102.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the invention not be limited to the particular embodiments disclosed, but will include all embodiments falling within the scope of the application.

What is claimed is:

1. A system for performing an operation at a vehicle, comprising:
a first acoustic transceiver that transmits and receives inaudible acoustic signals;
a second acoustic transceiver that is stationary with respect to the vehicle, wherein the second acoustic transceiver transmits and receives inaudible acoustic signals; and
a processor configured to:
receive an inaudible acoustic signal transmitted between the first acoustic transceiver and the second acoustic transceiver,
determine a location of the first acoustic transceiver with respect to the vehicle from the received signal, and
perform the operation at the vehicle based on the location of the first acoustic transceiver.

2. The system of claim 1, wherein the inaudible acoustic signal is one of: (i) transmitted from the first acoustic transceiver to the second acoustic transceiver; (ii) transmitted from the second acoustic transceiver to the first acoustic transceiver; and (iii) a signal transmitted from the first acoustic transceiver in response to an inaudible acoustic signal from the second acoustic transceiver.

3. The system of claim 2, wherein the inaudible acoustic signal is transmitted from the second acoustic transceiver to the first acoustic transceiver, further comprising one of: (i) determining the location at the first acoustic transceiver; and (ii) forwarding the received signal to the vehicle and determining the location at the vehicle.

4. The system of claim 1, wherein the second acoustic transceiver further comprises an array of second acoustic transceivers and the processor triangulates a location of the first acoustic transceiver from a plurality of transmitted and received signals transmitted between the array of second acoustic transceivers and the first acoustic transceiver.

5. The system of claim 4, wherein the transceivers of the array of second acoustic transceivers communicate sequentially with the first acoustic transceiver.

6. The system of claim 1, wherein the first acoustic transceiver is included in a hand-held mobile device.

7. The system of claim 6, wherein the mobile device transmits a security code to the vehicle and the processor activates the second transceiver when the security code matches a security code stored at the vehicle.

8. The system of claim 7, wherein the mobile device transmits the security code using electromagnetic signals.

9. The system of claim 7, wherein the security code is installed at the mobile device and provided to the vehicle from a remote location.

10. The system of claim 1, wherein performing the operation includes at least one of: (i) opening a door of the vehicle; (ii) starting the vehicle; (iii) connecting a phone call to the vehicle; (iv) sounding an alarm; (v) calling a separate phone; (vi) preventing the vehicle from being locked and (vii) sending an outgoing message to a remote system.

11. A method for performing an operation at a vehicle, comprising:
transmitting an inaudible acoustic signal between a first acoustic transceiver and a second acoustic transceiver affixed to the vehicle;
determining, at a processor, a location of the first acoustic transceiver with respect to the vehicle from the received signal; and
performing the operation at the vehicle based on the location of the first acoustic transceiver with respect to the vehicle.

12. The method of claim 11, wherein the inaudible acoustic signal is one of (i) transmitted from the first acoustic transceiver to the second acoustic transceiver; (ii) transmitted from the second acoustic transceiver to the first acoustic transceiver; and (iii) a signal transmitted from the first acoustic transceiver in response to an inaudible acoustic signal from the second acoustic transceiver.

13. The method of claim 12, wherein the inaudible acoustic signal is transmitted from the second acoustic transceiver to the first acoustic transceiver, further comprising one of: (i) determining the location at the first acoustic transceiver; and (ii) forwarding the received signal to the vehicle and determining the location at the vehicle.

14. The method of claim 11, wherein the second acoustic transceiver further comprises an array of second acoustic transceivers, further comprising triangulating a location of the first acoustic transceiver from a plurality of inaudible acoustic signals transmitted between the array of second acoustic transceivers and the first acoustic transceiver.

15. The method of claim 14, wherein the transceivers of the array of second acoustic transceivers communicate sequentially with the first acoustic transceiver.

16. The method of claim 11, wherein the first acoustic transceiver is included in a mobile device that is mobile with respect to the vehicle.

17. The method of claim 16, further comprising transmitting a security code from the mobile device to the vehicle and activating the second transceiver when the security code matches a security code stored at the vehicle.

18. The method of claim 17, wherein the mobile device transmits the security code using electromagnetic signals.

19. The method of claim 17, further comprising transmitting the security code to the mobile device from a remote location.

20. The method of claim 11, wherein performing the operation includes at least one of: (i) opening a door of the vehicle; (ii) starting the vehicle; (iii) connecting a phone call to the vehicle; (iv) sounding an alarm; (v) calling a phone; (vi) preventing the vehicle from being locked, and (vii) sending an outgoing message to a remote system.
